(19) United States
(12) Patent Application Publication
(10) Pub. No.: US 2009/0109174 A1
(43) Pub. Date: Apr. 30, 2009

(54) Method and Apparatus for User Interface in Electronic Devices With Visual Display Units

(76) Inventors: Gene S. Fein, Lenox, MA (US); Edward Merritt, Lenox, MA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/928,235

(22) Filed: Oct. 30, 2007

(51) Int. Cl. G09G 5/00

(52) U.S. Cl. 345/156

(57) ABSTRACT

A system for a 3-D user interface comprises: one or more 3-D projectors configured to display an image of all or one or more parts of a first electronic device in a 3-D coordinate system; one or more sensors configured to sense user interaction with the image and to provide user interaction information; and a processor configured (i) to receive the user interaction information from the one or more sensors; (ii) to correlate the user interaction with the image; and (iii) to operate a second electronic device in a manner responsive to a correlation of the user interaction with the image, wherein the first electronic device has a visual display unit and the image comprises an image of all or one or more parts of the visual display unit of the first electronic device. A method for providing a 3-D user interface comprises: generating an image of all or one or more parts of a first electronic device in a 3-D coordinate system; sensing user interaction with the image; correlating the user interaction with the image; and operating a second electronic device in a manner responsive to a correlation of the user interaction with the image, wherein the first electronic device has a visual display unit and the image comprises an image of all or one or more parts of the visual display unit of the first electronic device. Computer readable program codes related to the system and the method of the present invention are also described herein.

### BACKGROUND OF THE INVENTION

A graphical user interface (GUI) is a type of computer application user interface that allows people to interact with a computer and computer-controlled devices. A GUI typically employs graphical icons, visual indicators or special graphical elements, along with text, labels or text navigation to represent the information and actions available to a user. The actions are usually performed through direct manipulation of the graphical elements.

Holographic images can be created as single or consecutive images using available holographic technology. These technologies include mirrors, lasers, light and images strategically positioned to cause the proper reflection to yield a holographic image broadcast through an entry point in the laser and mirror positioning system. Black background and rooms with low or no light may enhance the appearance of the holographic image or images, which may also use a holographic plate as a display medium. Holographic systems may be large in size and spread out over a large broadcasting area or may be compact enough to fit in spaces smaller than a desk top. Holographic technology is only limited in size by the size of the component parts. By using holographic technology, images may be displayed multi-dimensionally, rather simply on a planar projection.

Currently progress has been made in technologies that can enhance the capability and range of holographic media in projects that employ multi-million mirror systems and via companies that have designed specialized high speed and high capacity micro processors for specialized jobs, other than holographic systems, where the technology could be applied to holographic technologies to make possible the proper positioning of millions of mirrors at a rate of between 24 to 60 or more frames of video per second, with corresponding synched audio.

Holographic displays generated over the last 20-year period utilize various configurations including lasers with images on glass plates such as an AGFA 8E75HD glass plate or other glass plates as well a laser such as a Spectra Physics 124B HeNe laser, a 35 mW laser diode system utilizing different processing methods such as pyrochrome processing. Split beam techniques can also be used Multi H1 to Multi H2. Such configurations as 8×10, triethanolomine, from Linotronic 300 image setter film are also commonly utilized or a configuration with rear-illuminated for 30×40 cm reflection hologram, where a logo floats 18-inches in front of the plate.

### SUMMARY OF THE INVENTION

Some user interfaces have adopted a multi-dimensional interface approach. For example, the “heliodisplay” of 102 Technology, LLC of San Francisco, Calif. projects images into a volume of free space, i.e. into an aerosol mixture such as fog or a gas, and may operate as floating touchscreen when connected to a PC by a USB cable. However, with the heliodisplay, the image is displayed into two-dimensional space (i.e. planar). While the Heliodisplay images appear 3 dimensional (“3-D”), the images are planar and have no physical depth reference.

Unfortunately, these existing uses have certain limitations in distribution and deployment. For example, functionally, the heliodisplay is a two dimensional display that projects against a curtain of air, or even glass. While, the heliodisplay may give the appearance of 3-D, the images displayed and the interface are 2-D. As such, the heliodisplay is not a true 3-D holographic display, and thus the interface operates on a two-dimensional plane, not taking advantage of a full three dimensional coordinate system.

Accordingly, there is a need for an integrated user interface that utilizes true 3-D technology to create a computing and multimedia environment where a user can easily navigate by touch, mouse or pointer system to effectively navigate the interface to raise the level of the user experience to a true 3-D environment, with the goal of attaining elements of the attenuated clarity, realism and benefits of that environment that match our day to day conventional interactions with the 3-D world. The present invention relates to the creation of a holographic user interface display system that combines physical media or digitally stored files with a digital holographic player hardware system. The result is the creation of a multimedia holographic user interface and viewing experience, where a variety of graphical schematics enabling cohesive access to information utilizing pyramids, blocks, spheres, cylinders, other graphical representations, existing templates, specific object rendering, free form association, user delegated images and quantum representations of information to form a user interface where the available tools combine over time to match a users evolving data and requests.

According to one aspect of the present invention, a system for a 3-D user interface comprises: one or more 3-D projectors configured to display an image of all or one or more parts of a first electronic device in a 3-D coordinate system; one or more sensors configured to sense user interaction with the image and to provide user interaction information; and a processor configured (i) to receive the user interaction information from the one or more sensors; (ii) to correlate the user interaction with the image; and (iii) to operate a second electronic device in a manner responsive to a correlation of the user interaction with the image. The first electronic device can have a visual display unit and the image can comprise an image of all or one or more parts of the visual display unit of the first electronic device. The system can further comprise a communications port coupled to the processor and configured to provide communications interface with a computer system. The first electronic device and the second electronic device can be the same. The first electronic device can comprise any of computers, telephones, televisions, calculators and other devices having at least one visual display unit. The image of all or one or more parts of the first electronic device can be a holograph. The user interaction with the image can comprise movement of the user relative to the image, or any sound produced by the user, or both. The one or more sensors can comprise any one or combination of location sensors, motion sensors, light sensors and sound sensors. The location sensors can comprise laser sensors configured to geometrically identify a position within the 3-D coordinate system. The light sensors can comprise any one or combination of photovoltaic sensors, image sensors and photo-electric light sensors. The sound sensors can comprise microphones. The processor can be further configured (iv) to provide one or more indications responsive to the correlation of the user interaction with the image; and (v) to display at least one of the provided indications in the image of all or one or more parts of the visual display unit of the first electronic device.

According to another aspect of the present invention, a method for providing a 3-D user interface comprises: generating an image of all or one or more parts of a first electronic device in a 3-D coordinate system; sensing user interaction with the image; correlating the user interaction with the image; and operating a second electronic device in a manner responsive to a correlation of the user interaction with the image. The first electronic device can have a visual display unit and the image can comprise an image of all or one or more parts of the visual display unit of the first electronic device. The first electronic device and the second electronic device can be the same. The first electronic device can comprise any of computers, telephones, televisions, calculators and other devices having at least one visual display unit. The image of all or one or more parts of the first electronic device can be a holograph. The user interaction with the image can comprise movement of the user relative to the image, or any sound produced by the user, or both. Sensing can comprise using one or more laser sensors to geometrically identify a position within the 3-D coordinate system. Using one or more laser sensors to geometrically identify a position within the 3-D coordinate system can comprise using laser sensors to triangulate or quadrilate the position within the 3-D coordinate system. Sensing can also comprise using a sound sensor to identify an audio input from the user. The method can further comprise providing one or more indications responsive to the correlation of the user interaction with the image, and displaying at least one of the provided indications in the image of all or one or more parts of the visual display unit of the first electronic device. The method can further comprise providing at least one of the provided indications to a device on a network. The indications provided to the device on the network can be the same as or different from the indications displayed in the image of all or one or more parts of the visual display unit of the first electronic device.

According to still another aspect of the present invention, a computer readable medium has computer readable program codes embodied therein for causing a computer to provide a 3-D user interface. The computer readable program codes can cause the computer to: generate an image of all or one or more parts of a first electronic device in a 3-D coordinate system; sense user interaction with the image; correlate the user interaction with the image; and operate a second electronic device in a manner responsive to a correlation of the user interaction with the image. The first electronic device can have a visual display unit and the image can comprise an image of all or one or more parts of the visual display unit of the first electronic device. The first electronic device and the second electronic device can be the same. The first electronic device can comprise any of computers, telephones, televisions, calculators and other devices having at least one visual display unit. The image of all or one or more parts of the first electronic device can be a holograph. The user interaction with the image can comprise movement of the user relative to the image, or any sound produced by the user, or both. Sensing can comprise using one or more laser sensors to geometrically identify a position within the 3-D coordinate system. Using one or more laser sensors to geometrically identify a position within the 3-D coordinate system can comprise using laser sensors to triangulate or quadrilate the position within the 3-D coordinate system. Sensing can also comprise using a sound sensor to identify an audio input from the user. The computer readable program codes can further cause the computer to provide one or more indications responsive to the correlation of the user interaction with the image, and to display at least one of the provided indications in the image of all or one or more parts of the visual display unit of the first electronic device. The computer readable program codes can further cause the computer to provide at least one of the provided indications to a device on a network. The indications provided to the device on the network can be the same as or different from the indications displayed in the image of all or one or more parts of the visual display unit of the first electronic device.

Embodiments of the invention provide a holographic user interface which transforms the computing environment to enable a three dimensional holographic style user interface and display system. The system utilizes holographic projection technology along with programmed quadrant matrixes sensor field to create multiple methods to select and interact with data and user interface tools and icons presented in a holographic format. The system may be used for interconnecting or communicating between two or more components connected to an interconnection medium (e.g., a bus) within a single computer or digital data processing system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating a holographic user interface according to an embodiment of the present invention;

FIG. 2 is a flow chart diagram illustrating a method for providing a 3 dimensional (3-D) interface with a system;

FIG. 3 is a perspective view of sensor field used in connection with embodiments of the present invention;

FIG. 4 is a front view of a holographic user interface device according to one embodiment of the present invention; and

FIG. 5 is a perspective view of a holographic user interface according to another embodiment of the present invention.

### DETAILED DESCRIPTION OF THE INVENTION

A description of example embodiments of the invention follows.

The present invention, in accordance with one embodiment relates to the creation of a holographic user interface which transforms the computing environment to enable a three dimensional (3-D) holographic style user interface and display system. The system utilizes holographic projection technology along with programmed quadrant matrixes sensor field to create multiple methods to select and interact with data and user interface tools and icons presented in a holographic format.

Systems related to holographic human machine interfaces have been previously described, e.g., in U.S. Pat. No. 6,031,519 entitled “Holographic Direct Manipulation Interface,” in U.S. Pat. No. 6,377,238 entitled “Holographic Control Arrangement,” and in U.S. Pat. No. 7,054,045 entitled “Holographic Human-Machine Interfaces,” teachings of all of which are incorporated herein by reference in their entirety, respectively. For more details on a specific holographic input device, a holographic keyboard displayed on a flat surface is described in greater details in U.S. Patent Application Number 20020070921 entitled “Holographic Keyboard,” teachings of which is incorporated herein by reference in its entirety.

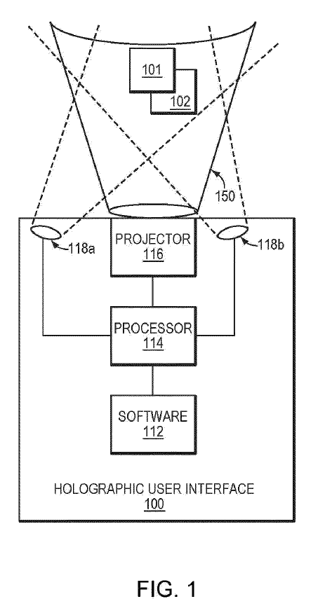

FIG. 1 illustrates a holographic user interface 100 according to one example embodiment of the present invention. The holographic user interface 100 includes a processor 114 that operates software 112, controls a holographic image projector 116, and processes information obtained from sensors 118a, 118b. The projector may generate a 3-D display image 101, 102 within a 3-D coordinate system 150. The sensors 118a and 118b may be directed toward the 3-D coordinate system to sense user interaction with images within the 3-D coordinate system. If a user were to interact with an image 101 or 102, the sensors 118a and 118b would provide coordinate information that the processor can correlate with the projected images 101 and 102 in the 3-D coordinate system.

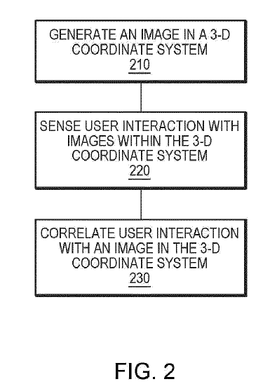

FIG. 2 is a flow chart that illustrates the method for providing a 3 dimensional (3-D) interface with a system. The interface generates (210) an image in a 3-D coordinate system. In operation, an embodiment of the interface deploys holographic information in the form of a user interface template as a default once turned on. Sensors on the interface sense (220) a user's interaction with the 3-D coordinate system. The sensing may occur through the use of matrixes or triangulated data points that correspond to specific functions and data display which the system is capable of displaying. The interface may then correlate (230) the user's interaction with an image in the 3-D coordinate system. By sensing and correlating interaction with the 3-D coordinate system, the interface allows a computer system or display to interact with a user. The holographic data displayed by the system becomes a result of a selection process by the user who triggers data being displayed by key strokes or by the use of a three dimensional interactive interface. Users location commands are read by the system at their exact points and then the system deploys the appropriate response or holographic media based upon the users specific request made via the location of that request.

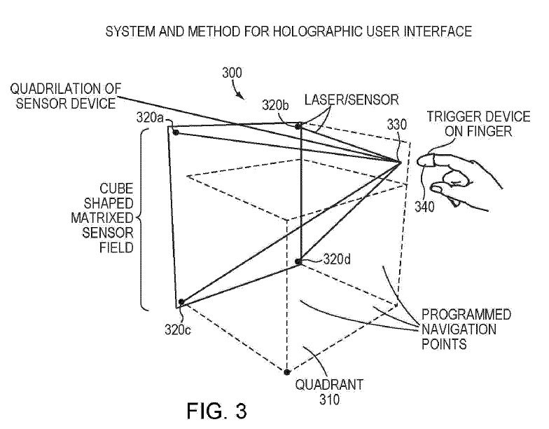

FIG. 3 illustrates a sensor field used in connection with embodiments of the present invention. The embodiment illustrated in FIG. 3 includes four laser sensors 320a-d. The manipulatable interface may be a relatable and interactive holographic media via the use of a sprocketed sensor system which deploys from the display either via a built in or retrofit hardware peripheral that creates a quadrilateral angle navigation system to determine the exact point 330 of a fingertip touch point 340 within a quadrant 310 (also referred to as a “3-D coordinate system”). This touch point, if effectively deployed by the user, is mapped to the image deployed by the holographic hardware and software system, as each image that is displayed in the system is displayed from an exacting point at an exacting place in space that has been preconfigured to match specific points on the quadrilateral sensor system. The points in space attached to programmed images are then matched to touch points made by the user. The touch point may trigger the same functions as a mouse and cursor.

One skilled in the art will recognize that other sensing configurations or devices may be used to sense a location within a 3-D coordinate system. For example, the sensors may be laser sensors configured to provide data to triangulate a point within the 3-D coordinate system, photo voltaic sensors, photo electric light sensors, or image sensors. The sensors may be programmed to identify the specific location of the touchpoint 330 that may extend through multiple planar images, to identify a single image located at a 3-D coordinate space.

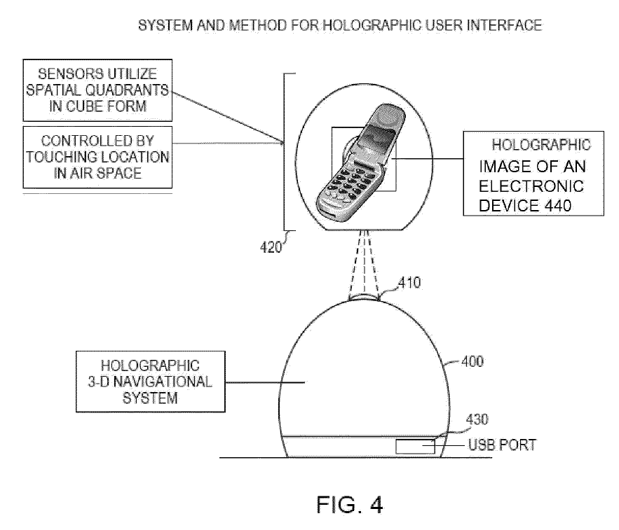

FIG. 4 illustrates a holographic user interface device 400 according to one embodiment of the present invention. The device 400 has a port 410 that may provide the output projector for the multi-dimensional display, and also the sensors for detecting user interaction. The projector and sensors map out a 3-D coordinate system 420 to serve as the holographic user interface. A communications port 430, such as a universal serial bus (“USB”) port or wireless connection, serves to allow the device 400 to communicate with a computer system. The 3-D coordinate system may comprise an image of all or one or more parts of an electronic device 440 having a visual display unit, wherein the image comprises an image of all or one or more parts of the visual display unit of the electronic device. As illustrated in FIG. 4 as an example, the 3-D coordinate system comprises an image of a cellular phone 440 having a screen as a visual display unit. All of the screen of the cellular phone is included in the 3-D coordinate system. However, the 3-D coordinate system may comprise an image of only part of the screen of the cellular phone. Any system that utilizes holographic displays may also be manipulated and selected using the sensor interface system.

The electronic device 440 displayed in the 3-D coordinate system may or may not be the same device as device 400. In the case that they are the same device, in effect, an image of all or one or more parts of device 400 is displayed in the 3-D coordinate system. For example, the invention may be embodied in a cellular phone capable of displaying an image of all or one or more parts of itself in a 3-D coordinate system.

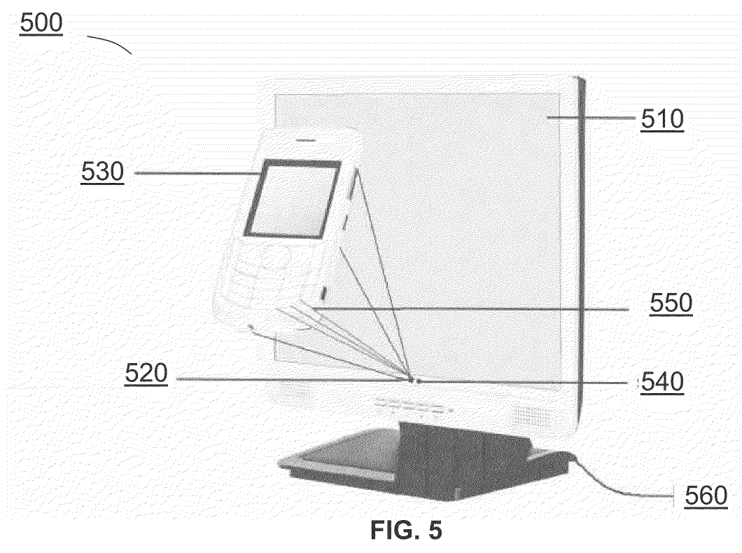

In other embodiments of the present invention, the electronic device 440 displayed in the 3-D coordinate system can be totally different from device 400. An example of such embodiment is illustrated in FIG. 5, where an image of a cellular phone is displayed by a projector embedded in an liquid crystal display (LCD) monitor of a computer and sensors aligned with each key on the cellular phone are also embedded in the computer monitor. FIG. 5 is a perspective view of a diagram of a holographic user interface 500 according to another embodiment of the present invention. The holographic user interface device may operate with a projection screen in the form of a computer monitor 510 and containing a holographic projector 520 projecting a holographic projection of a phone 530. A plurality of sensors 540 are also included in the projection screen, some of which are aligned with each key on the phone 550. The projection screen can be connected with a personal computer 560.

Any electronic device or one or more parts thereof having at least one visual display unit may be displayed in the 3-D coordinate system. Such electronic devices are often used in entertainment, communications and productivity. Non-limiting examples of such electronic devices include computers, telephones, televisions, and electronic clocks, watches and calculators. As used herein, “visual display units” refer to parts of an electronic device that offer visual presentation of information processed by the electronic device. Visual display units of electronic devices can be generally categorized into analog and digital visual display units. Non-limiting examples of analog visual display units include Cathode ray tube. Non-limiting examples of digital visual display units current or forthcoming in the market include bistable displays, electronic paper displays, nixie tube displays, vacuum fluorescent displays, light-emitting diode displays, electroluminescent displays, plasma displays, liquid crystal displays, organic light-emitting diode displays, surface-conduction electron-emitter displays, laser TV displays. Non-limiting examples of experimental digital visual display units include carbon nanotube displays and nanocrystal displays. A visual display unit commonly provides visual output function of an electronic device, e.g., computer monitors, telephone screens, television screens and calculator screens. Some visual display units can also serve as input means for an electronic device, for example, in the form of a touch screen, a touch-sensitive display screen, wherein touching different portions of the screen with a finger will cause the electronic device to take actions determined by a program.

User interaction with the image of all or one or more parts of the electronic device displayed can comprise movement of the user relative to the image, or any sound produced by the user, or both. User interaction with the image in the way of movements of the user can be either discrete (e.g., the same movement as that of pressing a key) or continuous (e.g., the same movement as that of dragging across a touch screen). The movement can be either unidimensional or multi-dimensional. While discrete movements are typically unidimensional, continuous movements can be either unidimensional or multi-dimensional. To sense the user interaction with the image accordingly, the sensors can comprise any one or combination of location sensors, motion sensors, light sensors and sound sensors. The location sensors can comprise laser sensors, which can be configured to geometrically identify a position within the 3-D coordinate system. Non-limiting examples of light sensors include photovoltaic sensors, image sensors and photo-electric light sensors. A typical example of sound sensors used in electronic devices is a microphone.

Movement of the user relative to the image can involve mechanical motion of the whole body or one or more body parts of the user relative to the image. For example, a typical user interaction with a cellular phone is pressing different keys in the phone's key pad using one's finger, The location sensors can be aligned with each key on the keypad of the cellular phone in the image displayed, sense the location of the finger relative to each key and provide user interaction information. A processor of the device 400 can receive information about such user interaction with the image and correlate the user interaction with the image, e.g., correlate the locations of the finger relative to each key to actions of pressing the keys. For example, if the location of the finger is within a certain distance to a key or overlaps with the image of the key, then it is considered by the processor that the key is being pressed.

The processor can also operate device 400 or another device that communicates with device 400 in a manner responsive to a correlation of the user interaction with the image. For example, upon correlating user finger locations to inputting a phone number and calling the number by actions of pressing appropriate keys in the cellular phone as displayed, device 400 can dial the number, just as a phone would do. Device 400 does not have to be a phone by itself, though, as long as it can provide or cause one or more other devices to provide appropriate phone functions which can be elicited by interacting with the image of all or one or more parts of the phone in the 3-D coordinate system. For example, device 400 can be a computer that can provide appropriate functions a phone can provide. Computers of this kind are well known to those skilled in the art. Alternatively device 400 can communicate with a computer system capable of providing appropriate phone functions, via, for example, a USB or wireless interface.

User interaction can also comprise any sound produced by the user. Such sound can be sensed by a sound sensor and correlated by a processor as an audio input to device 400. For example, if the electronic device displayed in the image is perceived to have the functionality of receiving audio input (e.g., a phone is known to have a receiver to pick up the voice), then device 400 can have the functionality of receiving audio input (e.g., by a sound sensor). Either device 400 or another device to which device 400 can communicate can further convert and/or transmit the audio input, if such functions can be found for the electronic device as displayed in the image. Device 400, with or without combination with one or more other devices, can provide basic functions the electronic device as displayed in the image is expected to have. In the case where the image is that of a phone, for example, device 400 or another device to which device 400 can communicate can also have the function of audio output (e.g., in the form of a speaker), just as a phone would. Device 400, with or without combination with one or more other devices, may provide other functions which may not be typically expected for the electronic device as displayed in the image to have. For example, an audio input can be in the form of a voice command, wherein the processor can correlate the voice command (voice recognition) and operate device 400 or a device that communicates with it in a mariner as dictated by the voice command, while voice recognition may not be expected as a necessary function of the electronic device as displayed in the image. The operation dictated by the voice command, however, is preferably related to a function of the electronic device as displayed in the image, e.g., a user may use voice command to dial a number if the electronic device displayed in the image is a telephone, even though voice recognition is not generally found as a basic function of a telephone.

In addition to operating device 400 or another device that communicates with device 400, one or more indications can be provided responsive to the correlation of the user interaction with the image and at least one of the provided indications can be displayed in the image of all or one or more parts of the visual display unit of the electronic device displayed in the image. For example, user interaction (movement of the user or sound produced by the user, or both) with the image of a cellular phone elicits displaying a contact's information, a basic function of a cellular phone. The contact's information can be displayed on the screen of the cellular phone as part of the image of the phone in real-time. In addition to functioning as a real-time visual output unit of an electronic device displayed in a 3-D image, the visual display unit in the 3-D image of the electronic device may also function as an input unit. For example, a user may interact with a real-time visual display unit of an image of an electronic device by moving a finger relative to the visual display unit. A processor can receive such user interaction with the visual display unit and correlate the user interaction with the visual display unit, e.g., correlate the locations of the finger relative to one or more items displayed in the visual display unit to actions of touching the visual display unit at the one or more items displayed therein, as if the visual display unit is a touch screen. For example, if the location of the finger is within a certain distance to an item in the visual display unit or overlaps with the image of the item, then it is considered by the processor that the item in the visual display unit is being pressed.

The image in the 3-D coordinate system can essentially become a virtual electronic device with visual output capabilities, wherein the whole image, including the visual output in the image are displayed by one or more 3-D projectors, and other functions of the electronic device as displayed can be provided by the same device that projects the image or one or more other devices that communicate with it. By interacting with the image of an electronic device in the 3-D coordinate system, a user can utilize the functions of such an electronic device in the absence of an actual device or when using an actual device is inconvenient. There are numerous advantages for doing so. Sometimes the actual electronic devices are too big to carry and affect mobility of the users needing them. Instead of using the actual device, those people can interact with the 3-D image of the device generated by a much smaller device on the go without having to worry about where to store the actual, bigger device. Sometimes people with visual impairment may find certain electronic devices too small to operate and the display too small to see clearly. The system according to the present invention can provide a 3-D image of the electronic device much larger than the actual device. Instead of using the actual device, those people can interact with the 3-1) image of the device much more easily and find the display therein much more visible.

Those of ordinary skill in the art should recognize that methods involved in providing a 3-D user interface with a system may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as electromagnetic signals propagating on a computer network, a bus or a communications link, either optical, wired, or wireless, carrying program code segments as digital or analog data signals. The program code enables and supports computer implementation of the operations described in FIGS. 1 and 2 or other embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A system for a 3 dimensional (3-D) user interface, the system comprising:
one or more 3-D projectors configured to display an image of all or one or more parts of a first electronic device in a 3-D coordinate system;
one or more sensors configured to sense user interaction with the image and to provide user interaction information; and
a processor configured (i) to receive the user interaction information from the one or more sensors; (ii) to correlate the user interaction with the image; and (iii) to operate a second electronic device in a manner responsive to a correlation of the user interaction with the image,
wherein the first electronic device has a visual display unit and the image comprises an image of all or one or more parts of the visual display unit of the first electronic device.

2. The system of claim 1, further comprising a communications port coupled to the processor and configured to provide communications interface with a computer system.

3. The system of claim 1, wherein the first electronic device and the second electronic device are the same.

4. The system of claim 1, wherein the first electronic device comprises any of computers, telephones, televisions, calculators and other devices having at least one visual display unit.

5. The system of claim 1, wherein the image of all or one or more parts of the first electronic device is a holograph.

6. The system of claim 1, wherein the user interaction with the image comprises movement of the user relative to the image, or any sound produced by the user, or both.

7. The system of claim 1, wherein the one or more sensors comprise any one or combination of location sensors, motion sensors, light sensors and sound sensors.

8. The system of claim 7, wherein the location sensors comprise laser sensors configured to geometrically identify a position within the 3-D coordinate system.

9. The system of claim 7, wherein the light sensors comprise any one or combination of photovoltaic sensors, image sensors and photo-electric light sensors.

10. The system of claim 7, wherein the sound sensors comprise microphones.

11. The system of claim 1, wherein the processor is further configured (iv) to provide one or more indications responsive to the correlation of the user interaction with the image; and (v) to display at least one of the provided indications in the image of all or one or more parts of the visual display unit of the first electronic device.

12. A method for providing a 3 dimensional (3-D) user interface, the method comprising:
generating an image of all or one or more parts of a first electronic device in a 3-D coordinate system;
sensing user interaction with the image;
correlating the user interaction with the image; and
operating a second electronic device in a manner responsive to a correlation of the user interaction with the image,
wherein the first electronic device has a visual display unit and the image comprises an image of all or one or more parts of the visual display unit of the first electronic device.

13. The method of claim 12, wherein the first electronic device and the second electronic device are the same.

14. The method of claim 12, wherein the first electronic device comprises any of computers, telephones, televisions, calculators and other devices having at least one visual display unit.

15. The method of claim 12, wherein the image of all or one or more parts of the first electronic device is a holograph.

16. The method of claim 12, wherein the user interaction with the image comprises movement of the user relative to the image, or any sound produced by the user, or both.

17. The method of claim 12, wherein sensing comprises using one or more laser sensors to geometrically identify a position within the 3-D coordinate system.

18. The method of claim 17, wherein using one or more laser sensors to geometrically identify a position within the 3-D coordinate system comprises using laser sensors to triangulate or quadrilate the position within the 3-D coordinate system.

19. The method of claim 12, wherein sensing comprises using a sound sensor to identify an audio input from the user.

20. The method of claim 12, further comprising providing one or more indications responsive to the correlation of the user interaction with the image, and displaying at least one of the provided indications in the image of all or one or more parts of the visual display unit of the first electronic device.

21. The method of claim 20, further comprising providing at least one of the provided indications to a device on a network, wherein the indications provided to the device on the network are the same as or different from the indications displayed in the image of all or one or more parts of the visual display unit of the first electronic device.

22. A computer readable medium having computer readable program codes embodied therein for causing a computer to provide a 3 dimensional (3-D) user interface, the computer readable program codes causing the computer to:
generate an image of all or one or more parts of a first electronic device in a 3-D coordinate system;
sense user interaction with the image;
correlate the user interaction with the image; and
operate a second electronic device in a manner responsive to a correlation of the user interaction with the image,
wherein the first electronic device has a visual display unit and the image comprises an image of all or one or more parts of the visual display unit of the first electronic device.

23. The computer readable medium of claim 22, wherein the first electronic device and the second electronic device are the same.

24. The computer readable medium of claim 22, wherein the computer readable program codes further cause the computer to provide one or more indications responsive to the correlation of the user interaction with the image, and to display at least one of the provided indications in the image of all or one or more parts of the visual display unit of the first electronic device.

25. The computer readable medium of claim 24, wherein the computer readable program codes further cause the computer to provide at least one of the provided indications to a device on a network, wherein the indications provided to the device on the network are the same as or different from the indications displayed in the image of all or one or more parts of the visual display unit of the first electronic device.
